(19) United States
(12) Patent Application Publication
(10) Pub. No.: US 2022/0326741 A1
(43) Pub. Date: Oct. 13, 2022

(54) ELECTRONIC DEVICE DISPLAY PANELS

(71) Applicant: HEWLETT-PACKARD DEVELOPMENT COMPANY, L.P., Spring, TX (US)

(72) Inventors: Hyunmin MOON, Spring, TX (US); Jin Sang HWANG, Spring, TX (US)

(21) Appl. No.: 17/224,921

(22) Filed: Apr. 7, 2021

(51) Int. Cl. G06F 1/16

(52) U.S. Cl. CPC G06F 1/1681; G06F 1/169; G06F 1/1662

(57) ABSTRACT

An example electronic device includes an input device. In addition, the electronic device includes a first display panel pivotably coupled to the keyboard via a hinge. Further, the electronic device includes a second display panel slidingly coupled to the first display panel such that the second display panel is to slide along the first display panel toward or away from the hinge.

### BACKGROUND

Electronic devices may be mobile electronic devices that are transported from place to place. In addition, electronic devices may include display panels that are to display images (e.g., text, graphics, video, pictures) during operations.

### BRIEF DESCRIPTION OF THE DRAWINGS

Various examples will be described below referring to the following figures:

FIGS. 1 and 2 are schematic side views of an electronic device including a pair of sliding display panels according to some examples;

FIG. 3 is an enlarged side view of a plurality of magnets coupled to a housing member of the electronic device of FIGS. 1 and 2 according to some examples;

FIG. 4 is an enlarged side view of stop surfaces coupled to the housing member of the electronic device of FIGS. 1 and 2 according to some examples;

FIGS. 5-7 are perspective views of an electronic device including a pair of sliding display panels according to some examples;

FIG. 8 is a cross-sectional view taken along section 8-8 in FIG. 1 according to some examples;

FIGS. 9-11 are sequential rear views of a housing member of the electronic device of FIGS. 1 and 2 showing an actuation of a biasing assembly as the pair of sliding display panels are actuated relative to one another according to some examples; and

FIG. 12 is a block diagram of the electronic device of FIGS. 1 and 2 according to some examples.

### DETAILED DESCRIPTION

A mobile electronic device may include a display panel that is to display images during operations. To enhance a user's experience, a display panel may be as large as possible. However, the mobile nature of the mobile electronic device may place limits on the total size of the display panel. Specifically, if a display device is oversized, the overall dimensions of the electronic device may be too large to fit within standard sized receptacles (e.g., bags, pockets, sleeves) that may be used for transporting the mobile electronic device.

Accordingly, examples disclosed herein include electronic devices that include a pair of display panels that may be slidable relative to one another to selectively increase an available surface area for displaying images on the electronic devices during operations. In addition, when the additional display surface area is not needed or desired, a user may slide the display panels relative to one another to occlude one of the pair of display panels and thereby decrease an overall dimension of the electronic device. Through use of the slidable display panels of the examples disclosed herein, a user may selectively increase or decrease the available surface area on the electronic device for displaying images to enhance both the user experience during operations and help facilitate the transportability of the electronic device.

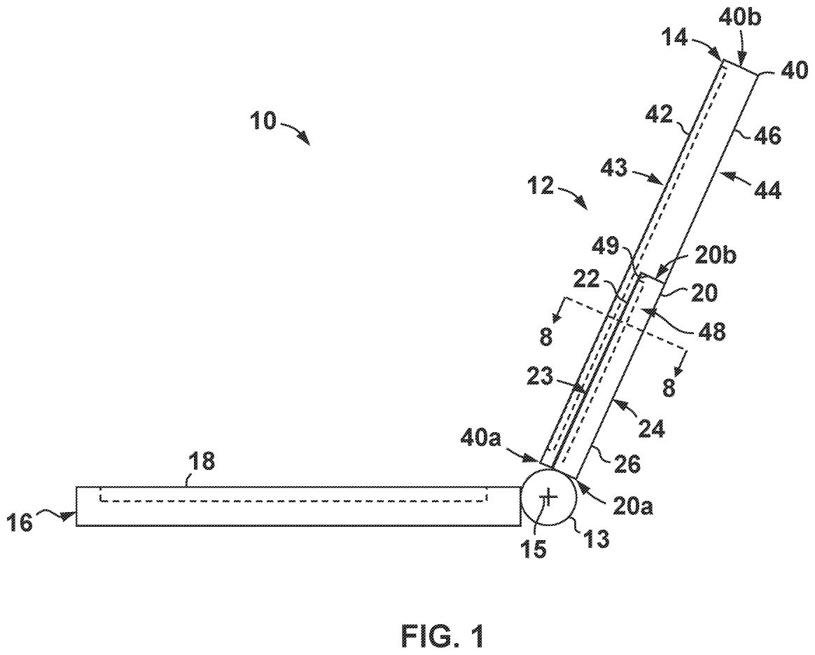

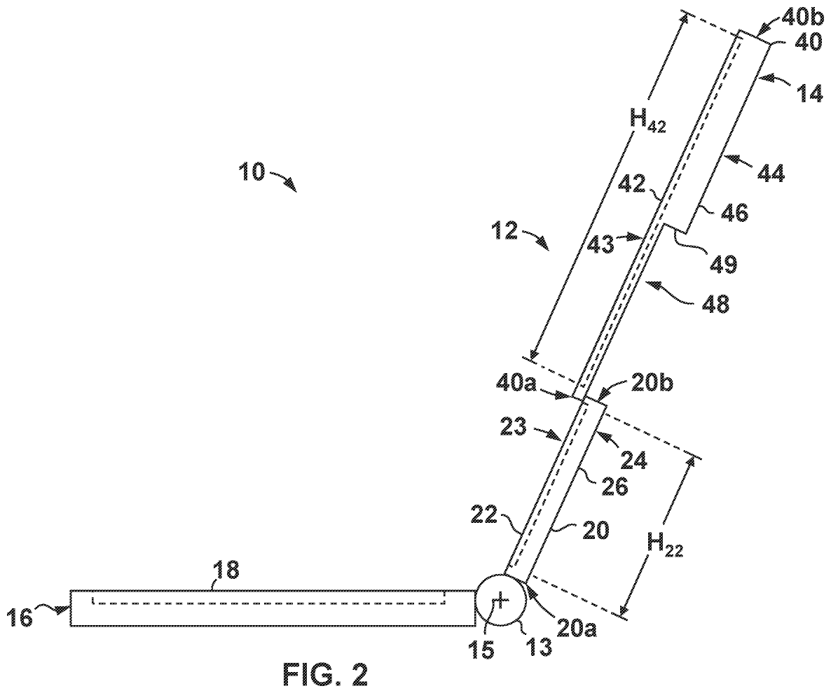

Referring now to FIGS. 1 and 2, an electronic device 10 including a pair of sliding display panels 20, 40 according to some examples is shown. As used herein, the term “electronic device” refers to any device that may execute machine-readable instructions. For instance, an electronic device may comprise (but is not limited to) a desktop computer, a laptop computer, a tablet computer, a smartphone, an all-in-one computer, etc. The electronic device 10 of FIGS. 1 and 2 comprises a laptop computer including a housing 12 comprising a first housing member 14 and second housing member 16 rotatably coupled to one another via a hinge 13. Thus, the first housing member 14 and second housing member 16 may rotate relative to one another about an axis of rotation 15 via hinge 13.

The second housing member 16 includes an input device 18. Input device 18 may comprise any device or collection of devices that are to receive user inputs for electronic device 10 during operations. For instance, in some examples input device 18 comprises a keyboard including a plurality of keys (e.g., physical keys or digital keys formed on a display) that may be engaged by a user to provide inputs to electronic device 10. In some examples, input device 18 comprises (e.g., in addition to or alternatively to other input devices) a touch sensitive surface, such as a trackpad, that is to detect and touch inputs (e.g., via a user's finger, a stylus, or other suitable device or object).

Referring still to FIGS. 1 and 2, first housing member 14 comprises a first display panel 20, and a second display panel 40. The second display panel 40 is slidably coupled to the first display panel 20 such that during operations, the second display panel 40 may be transitioned between a first position shown in FIG. 1 in which the second display panel 40 occludes the first display panel 20, and a second position shown in FIG. 2 in which the second display panel 40 is translated away from the hinge 13 (e.g., along or parallel to a radius of axis 15) relative to first display panel 20, such that the first display panel 20 is exposed for viewing by a user.

First display panel 20 includes a first or inner end 20a and a second or outer end 20b opposite inner end 20a. The first display panel 20 may be coupled to the hinge 13 at the inner end 20a, such that the outer end 20b extends outward and away from hinge 13. In addition, first display panel 20 includes a front side 23 and a rear side 24 opposite the front side 23. Front side 23 includes a display surface 22. Rear side 24 includes a rear surface 26, which may comprise a planar surface in some examples. Because the rear surface 26 is positioned on rear side 24, and display surface 22 is positioned on front side 23, the rear surface 26 may be opposite the display surface 22.

First display panel 20 may project or display images from the display surface 22. First display panel 20 may utilize any suitable display type or structure. For instance, in some examples, first display panel 20 may comprise a liquid crystal display (LCD), a light emitting diode (LED) display (e.g., an organic LED (OLED) display, a micro LED display), a plasma display, etc. The display surface 22 may comprise a height H₂₂ measured along or parallel to a radius of axis 15.

Second display panel 40 includes a first or inner end 40a and a second or outer end 40b opposite inner end 40a. In addition, second display panel 40 includes a front side 43 and a rear side 44 opposite front side 43. Front side 43 includes a display surface 42. Rear side 44 includes a rear surface 46 and a recess 48 extending into second display panel 40 from rear surface 46 to define a shoulder 49. Rear surface 46 extends from outer end 40b to shoulder 49, and recess 48 extends from shoulder 49 to inner end 40a.

Second display panel 40 may project or display images from the display surface 42. Second display panel 40 may utilize any suitable display type or structure, such as, for instance an LCD, an OLED display, a micro-LED display, a plasma display, etc. The display surface 42 may comprise a height H₄₂ measured along or parallel to a radius of axis 15.

The height H₄₂ may be greater than the height H₂₂ (that is, the height H₂₂ may be less than the height H₄₂). In some examples, the height H₂₂ may be half (e.g., 50%) the height H₄₂ and the widths (extending into the page for FIGS. 1 and 2 in a direction that is perpendicular to the heights H₂₂, H₄₂) may be equal (or substantially equal), such that when the second display panel 40 is transitioned to the second position (FIG. 2), the total visible surface area for displaying images on electronic device 10 may be increased by about 50% from the first position (FIG. 1). However, other relative sizes of display surfaces 22, 42 (e.g., heights H₂₂, H₄₂) are contemplated in other examples. For instance, in some examples the height H₂₂ may be greater than the height H₄₂, or the heights H₂₂, H₄₂ may be equal (or substantially equal).

The first display panel 20 is received within the recess 48 of second display panel 40. Thus, during operations when second display panel 40 is in the first position (FIG. 1), the outer end 20b of first display panel 20 may be abutted with the shoulder 49, and the rear surfaces 46, 26 may be flush with one another. As a result, when the second display panel 40 is in the first position (FIG. 1), the first display panel 20 may fill (or substantially fill) the recess 48 and the rear surfaces 26, 46 of display panels 20, 40 form a smooth back side of first housing member 14. As used herein the term “smooth” means free from irregularities or projections. Thus, a “smooth” back side of first housing member 14 means that the back side of the first housing member 14 formed by the rear surfaces 26,46 may have a profile extending across the junction of rear surfaces 26, 46 that is free of irregularities or projections when second housing member 16 is in the first position (FIG. 1). In addition, when the second display panel 40 is in the second position (FIG. 2), the shoulder 49 may be spaced from outer end 20b of first display panel 20 such that recess 48 is exposed (e.g., partially exposed).

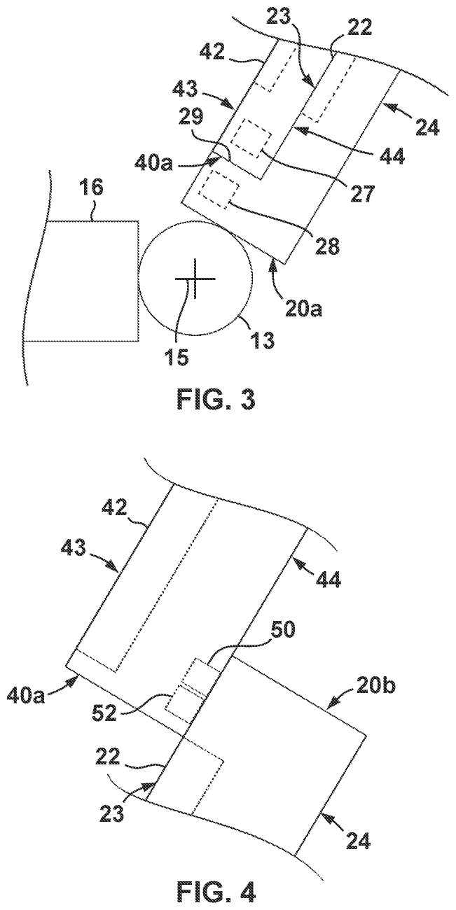

Referring now to FIG. 3, in some examples, the first housing member 14 may comprise a plurality of magnets 28, 27 coupled thereto that are to secure and hold the second display panel 40 in the first position (FIG. 1). In particular, as shown in FIG. 3, in some examples, the first display panel 20 may comprise a magnet 28 (or a plurality of magnets 28), and the second display panel 40 may comprise a magnet 27 (or a plurality of magnets 27).

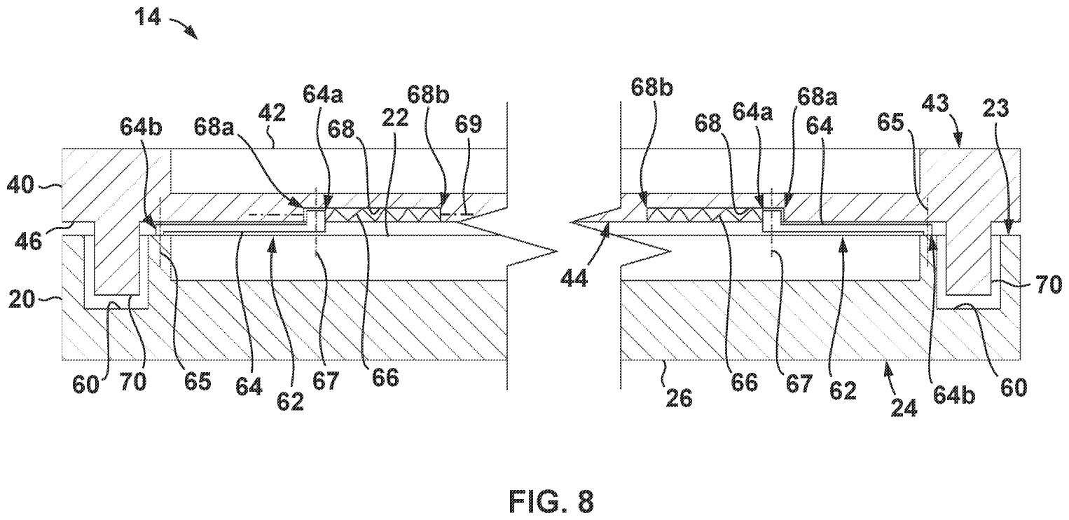

In some examples, the first display panel 20 may comprise a shoulder 29 positioned at (or proximate to) inner end 20a. When the second display panel 40 is in the first position (FIG. 1), the inner end 40a of second display panel 40 may abut shoulder 29. The magnet(s) 28 may be positioned within and/or on the shoulder 29 of first display panel 20, and the magnet(s) 27 may be positioned within and/or on the inner end 40a of second display panel 40. When the second display panel 40 is in the first position (FIG. 1), a magnetic attraction between the magnets 28, 27 may hold the inner end 40a against the shoulder 29. Thus, the magnetic attraction between magnets 28, 27 may hold the second display panel 40 in the first position (FIG. 1), and may therefore resist movement of the second display panel 40 to the second position (FIG. 2) away from the hinge 13 (e.g., along or parallel to a radius of the axis of rotation 15), to the second position (FIG. 2). In some examples, the magnets 27, 28 may be omitted and the second display panel 40 may be retained in the first position (FIG. 1) via other mechanisms (e.g., biasing assemblies 62 shown in FIG. 8 and discussed below), and in some examples, the magnets 27, 28 and other mechanisms (e.g., biasing assemblies 62) may retain second display panel 40 in the first position (FIG. 1).

The magnets 28, 27 may comprise permanent magnets or electromagnets. In some examples, the magnet(s) 28 may be positioned within the hinge 13. Thus, in some examples, shoulder 29 may be omitted from first display panel 20.

Referring now to FIG. 4, in some examples, first display panel 20 and/or second display panel 40 may include structures or surfaces for limiting the slidable range of second display panel 40 relative to first display panel 20 during operations. For instance, in some examples first display panel 20 and second display panel 40 may comprise stop surfaces 50, 52 that may engage when the second display panel 40 has reached the second position (FIG. 2), thereby limiting further translation of second display panel 40 relative to first display panel 20 away from hinge 13 (FIGS. 1 and 2). More specifically, first display panel 20 may comprise a first stop surface 50, and the second display panel 40 may comprise a second stop surface 52. During operations, when the second display panel 40 is transitioned from the first position (FIG. 1) to the second position (FIG. 2), the second stop surface 52 is translated relative to the first display panel 20 along with the second display panel 40 until the second stop surface 52 engages with the first stop surface 50. In some examples, the stop surfaces 50, 52 may be defined internally to first display panel 20 and second display panel 40.

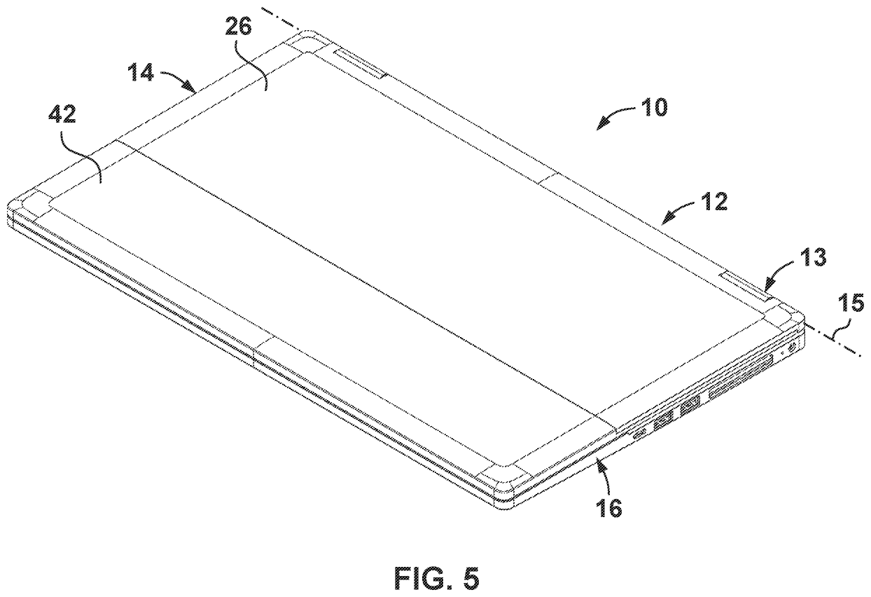

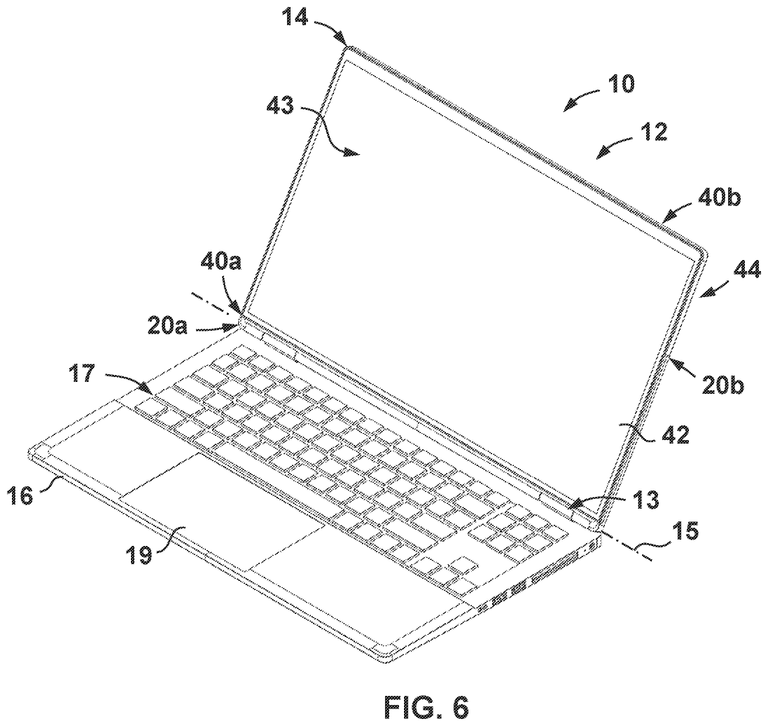

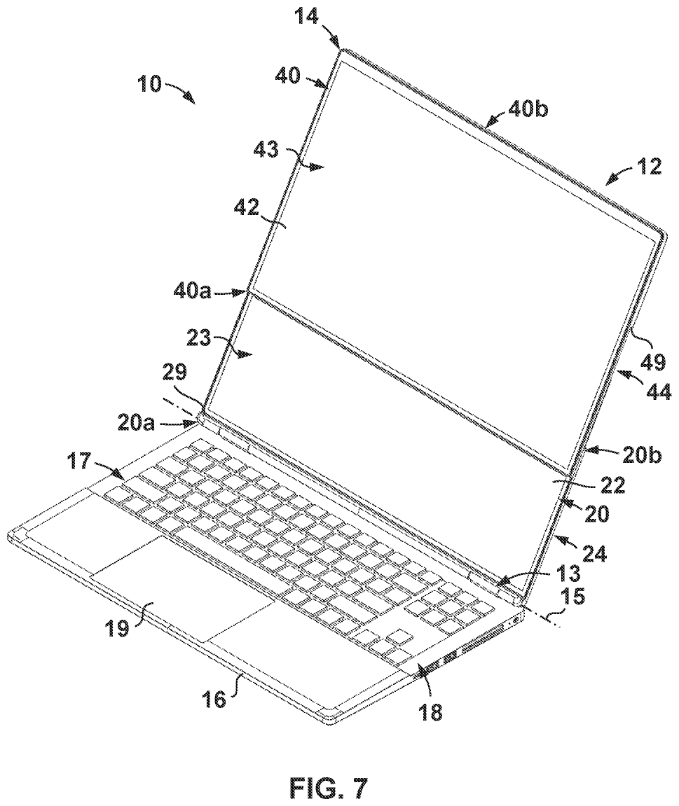

Referring now to FIGS. 5-7, in some examples, when the second display panel 40 is in the first position (FIGS. 1 and 6), the first housing member 14 may be rotated about the axis 15 of hinge 13 toward second housing member 16 to a closed position that may facility transportation of the electronic device 10 as shown in FIG. 5. Because the second display panel 40 is in the first position (FIGS. 1 and 6) when rotating the first housing member 14 to the closed position, the overall dimensions of electronic device 10 may be reduced in the closed position of FIG. 5. However, during operations, when the first housing member 14 is rotated about axis 15 via hinge 13 so as to expose the display surface 42, the second display panel 40 may then be transitioned to the second position (FIGS. 2 and 7) to expose the display surface 22 and therefore increase the available surface area on first housing member 14 for displaying images.

In some examples, when the second display panel 40 is in the second position (FIGS. 2 and 7), the first display panel 20 and the second display panel 40 may display the same or different content. For instance, the same image may be expanded across the display surfaces 22, 42 of the display panels 20, 40, respectively. In some examples, the first display panel 20 and second display panel 40 may display different images. For instance, in some examples, the display surface 42 of second display panel 40 may display images associated with a game or video, while the display surface 22 of the first display panel 20 may display images associated with a different application from the game or video (e.g., an internet browser). In some examples, a single application executed on electronic device 10 may output different images to the display panels 20, 40. For instance, in some examples, second display panel 40 may output a first content or image from the application (e.g., a photograph, drawing, or other image), while the first display panel 20 may output a second content or image from the application (e.g., an options menu for editing parameters of the photograph, drawing, or other images presented on the second display panel 40).

Referring specifically to FIG. 7, during operations, when the second display panel 40 is in the second position, the display surfaces 22, 42 of display panels 20, 40, respectively, may be positioned at substantially the same viewing angle (e.g., an angle extending between a vertically oriented line or plane to the display surfaces 22, 42). In addition, because both the display panels 20, 40 are pivotable about axis 15 via hinge 13, a user may simultaneously adjust the viewing angle of both display surfaces 22, 42 during operations via rotation of first housing member 14 about the axis 15 of hinge 13 which may simply use of the electronic device 10 (e.g., by avoiding independent manipulation of each display panel 20, 40 during operations).

Referring now to FIGS. 6 and 7, as previously described above, input device 18 may comprise a keyboard 17 and a trackpad 19. In some examples, the keyboard 17 may be positioned between the trackpad 19 and the hinge 13; however, other arrangements are contemplated. In addition, because both display panels 20, 40 are positioned within the first housing member 14, thermal heat transfer within the second housing member 16 is largely unaffected by display panels 20, 40. As a result, the design of second housing member 16, and in particular the design of second housing member 16 with respect to internal heat transfer, may be determined without giving consideration to the display panels 20, 40 (which also may therefore simplify the design for second housing member 16).

Referring now to FIG. 8, a schematic cross-section of first housing member 14 is shown along section 8-8 in FIG. 1. In some examples, second display panel 40 may include a projection 70 or (as shown in FIG. 8) a plurality of projections 70 that are received within a corresponding recessed track 60 or (as shown in FIG. 8) a plurality of recessed tracks 60 on first display panel 20. The engagement and/or interaction of projection(s) 70 and recessed track(s) 60 may facilitate and guide the sliding of second display panel 40 along and relative to first display panel 20 during operations. The projections 70 may extend outward (e.g., normally outward) from rear side 44 of second display panel 40 (e.g., within recess 48 shown in FIGS. 1 and 2), and recessed track(s) 60 may extend into front side 23 of first display panel 20.

In addition, in some examples, a biasing assembly 62 or (in the case of FIG. 8) a plurality of biasing assemblies 62 are coupled between the first display panel 20 and second display panel 40. As described in more detail below, biasing assembly (or assemblies) 62 are to bias the second display panel 40 to either the first position (FIG. 1) or the second position (FIG. 2) depending on the relative positions of the first display panel 20 and second display panel 40. More specifically, when the second display panel 40 is initially transitioned away from the first position (FIG. 1), the biasing assembly (or assemblies) 62 may bias the second display panel 40 back toward the first position (FIG. 1). However, when second display panel 40 is moved along first display panel 20 a sufficient distance from the first position, the biasing assembly (or assemblies) 62 may then bias the second display panel 40 toward the second position (FIG. 2).

The (or each) biasing assembly 62 includes a linking member 64 and a biasing member 66. Linking member 64 is an elongate member including a first end 64a pivotably coupled to second display panel 40, and a second end 64b that is pivotably coupled to first display panel 20. In some examples, biasing member 66 may comprise a coiled spring.

In particular, first end 64a of linking member 64 may be inserted within a slot or recess 68 extending into rear side 44 of second display panel 40, such that first end 64a may slide along recess 68 and may be pivotable about an axis 67 that extends normally to rear surface 46. The recess 68 may be elongated along an axis 69 that is generally parallel to the axis 15 (FIGS. 1 and 2), such that recess 68 includes a first end 68a and a second end 68b opposite first end 68a along axis 69. The biasing member 66 and first end 64a of linking member 64 are arranged within recess 68 so that biasing member 66 extends between second end 68b of recess 68 and first end 64a of linking member 64. During operation, first end 64a of linking member 64 may traverse along recess 68 between ends 68a, 68b to compress and extend biasing member 66 along axis 69, and may also pivot about axis 67. Second end 64b is pivotably coupled to front side 23 of first display panel 20 (e.g., via a pinned connection) such that linking member 64 may pivot about axis 65 relative to first display panel 20.

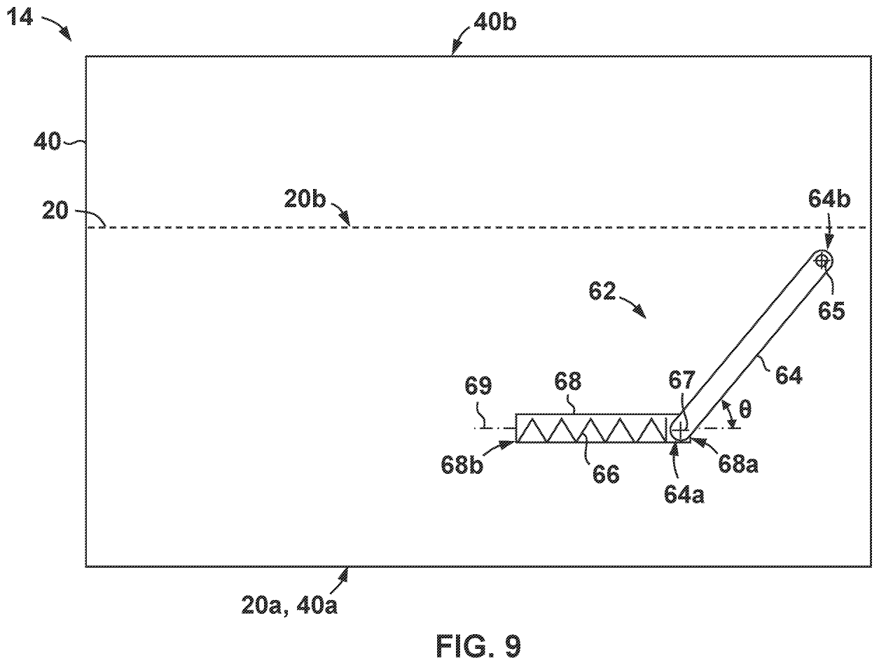

Referring now to FIGS. 9-11, in some examples, as second display panel 40 is transitioned between the first position (FIG. 1) and the second position (FIG. 2), the biasing assembly (or assemblies) 62 may actuate to bias second display panel 40 to the first position (FIG. 1) or the second position (FIG. 2) as generally described above. It should be noted that in FIGS. 9-11, the first display panel 20 is shown via dotted line to show the biasing assembly 62. In addition, it should also be noted that FIGS. 9-11 show one of the biasing assemblies 62 depicted in FIG. 8 to simplify the drawing.

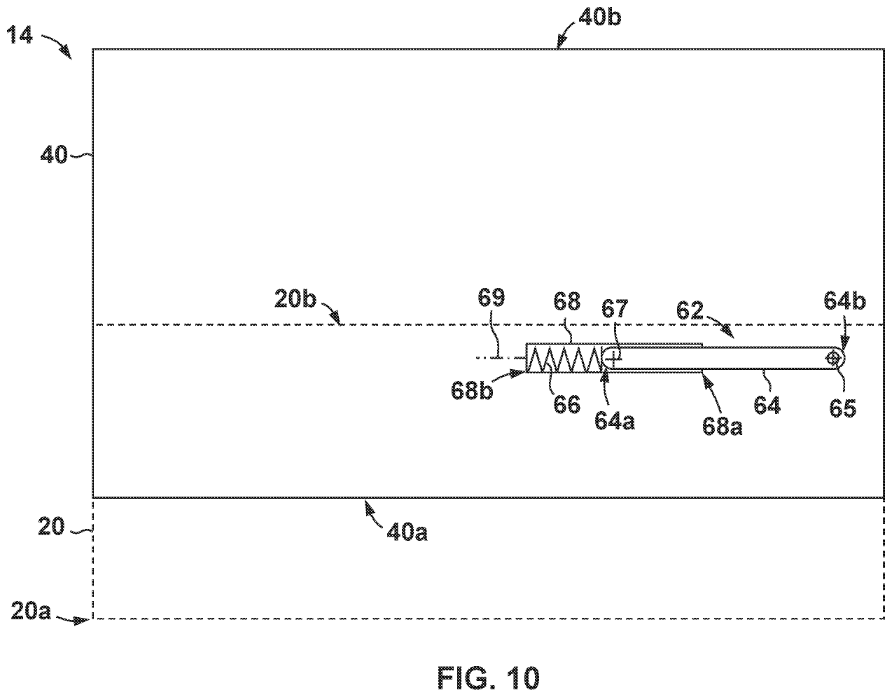

In particular, with particular reference to FIG. 9, initially when the second display panel 40 is in the first position (FIG. 1), the recess 68 and first end 64a of linking member 64 may be spaced from the second end 64b of linking member 64 so that first end 64a of linking member 64 is shifted within recess 68 toward first end 68a via the bias provided by biasing member 66. As a result, the linking member 64 extends at a positive angle θ relative to axis 69. Thus, any movement of second display panel 40 upward (according to the orientation shown in FIG. 9) relative to first display panel 20 toward the second position (FIG. 2) will also reduce the angle θ, and move the recess 68 and first end 64a of linking member 64 upward toward second end 64b. Because linking member 64 has a fixed length, as recess 68 and first end 64a move upward toward second end 64b, the linking member 64 is forced to rotate about axes 67, 65 such that first end 64a is shifted away from first end 68a and toward second end 68b of recess 68, which thereby compresses biasing member 66 such as shown in the progression from FIGS. 9 to 10. During these operations, while the first end 64a of linking member 64 is spaced below (in the orientation shown in FIGS. 9 and 10), to maintain a positive, non-zero value for the angle θ, the biasing member 66 may rotatably bias second end 64b of linking member 64 in a counterclockwise direction for the view shown in FIGS. 9 and 10, such that second display panel 40 is biased back toward the first position of FIG. 9 (and FIG. 1).

Referring specifically to FIG. 10, continued movement of the second display panel 40 relative to the first display panel 20 toward the second position eventually achieves a neutral position for the second display panel 40 in which the linking member 64 extends parallel (or substantially parallel) to the axis 69 of recess 68. In the neutral position of FIG. 10, the biasing member 66 is fully compressed but provides no rotational bias to linking member 64 about axis 65. In some examples, the neutral position of FIG. 10 may be achieved when the second display panel 40 is about halfway between the first position (FIG. 1) and the second position (FIG. 2).

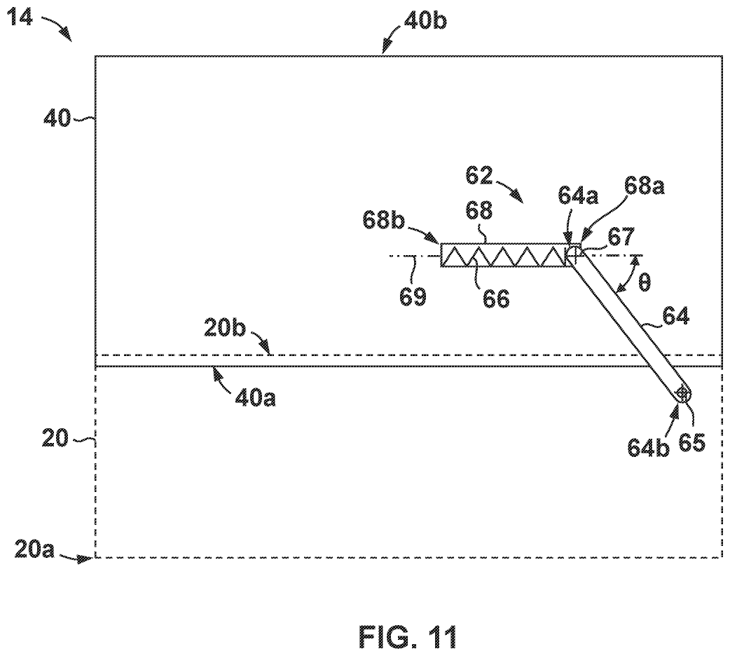

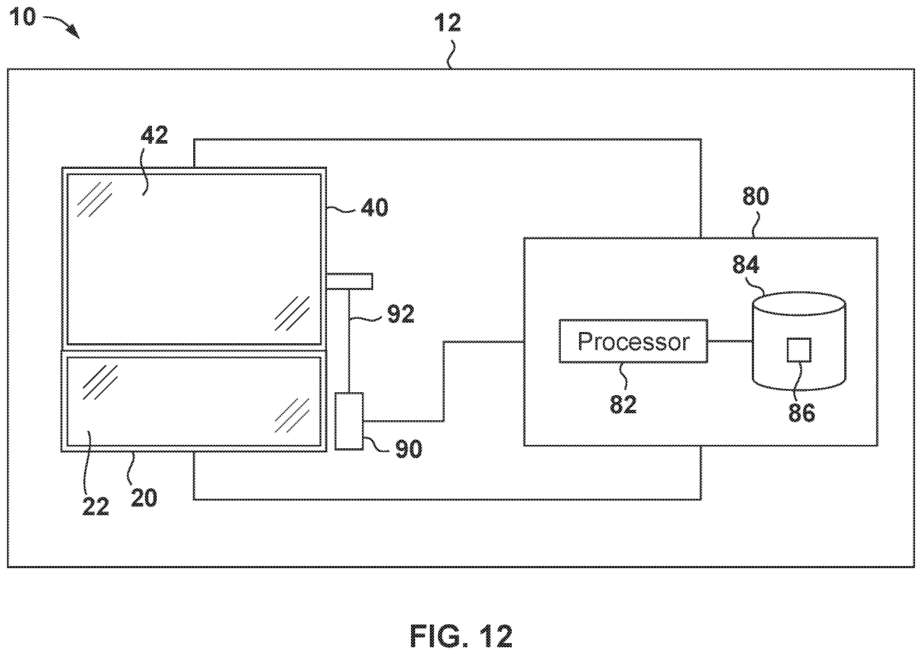

Referring now to FIG. 11, when the second display panel 40 is translated past the neutral position of FIG. 10 to further extend the second display panel 40 upward (in the orientation shown in FIG. 11) from the outer end 20b of first display panel 20 toward the second position (FIG. 2), the angle θ may become a non-zero, negative value and the first end 64a may be spaced above (in the orientation shown in FIG. 11) the second end 64b. During the motion of the second display panel 40 relative to the first display panel 20, as the angle θ becomes negative, the compressed biasing member 66 may begin to rotationally bias the linking member 64 about axis 65 in a clockwise direction for the view shown in FIG. 11. As a result, once the second display panel 40 passes the neutral position of FIG. 10 as it is extending upward from first display panel 20 (for the orientation shown in FIG. 11), the biasing assembly (or assemblies) 62 may bias the second display panel 40 toward the second position (FIGS. 2 and 11).

When second display panel 40 is transitioned from the second position (FIGS. 2 and 11) back to the first position (FIGS. 1 and 9), the biasing assembly (or assemblies) 62 may again initially bias the second display panel 40 back to the second position until the neutral position of FIG. 10 is achieved. Thereafter, the biasing assembly (or assemblies) 62 may begin to bias the second display panel 40 toward the first position (FIG. 1). Accordingly, when transitioning the second display panel 40 between the first position (FIG. 1) and the second position (FIG. 2), the biasing member(s) 66 of biasing assembly (or assemblies) 62 may be initially compressed and then expanded so as to initially resist and then assist in the movement of the second display panel 40 as described above.

Referring now to FIG. 12, in some examples, electronic device 10 includes a controller 80 positioned within housing 12. The controller 80 includes a processor 82 and a memory 84 coupled to processor 82.

The processor 82 may comprise any suitable processing device, such as a microcontroller, central processing unit (CPU), graphics processing unit (GPU), timing controller (TCON), a scaler unit. The processor 82 executes machine-readable instructions (e.g., machine-readable instructions 86) stored on memory 84, thereby causing the processor 82 (and, more generally, electronic device 10) to perform some or all of the actions attributed herein to the processor 82 (and, more generally, to electronic device 10). In general, processor 82 fetches, decodes, and executes instructions (e.g., machine-readable instructions 86). In addition, processor 82 may also perform other actions, such as, making determinations, detecting conditions or values, etc., and communicating signals. If processor 82 assists another component in performing a function, then processor 82 may be said to cause the component to perform the function.

The memory 84 may comprise volatile storage (e.g., random access memory (RAM)), non-volatile storage (e.g., flash storage, etc.), or combinations of both volatile and non-volatile storage. Data read or written by the processor 82 when executing machine-readable instructions 86 can also be stored on memory 84. Memory 84 may comprise “non-transitory machine readable medium.”

The processor 82 may comprise one processing device or a plurality of processing devices that are distributed within electronic device 10 (e.g., distributed within first housing member 14 and/or second housing member 16). Likewise, the memory 84 may comprise one memory device or a plurality of memory devices that are distributed within the electronic device 10 (e.g., distributed within first housing member 14 and/or second housing member 16).

Controller 80 may be coupled to both the first display panel 20 and second display panel 40. During operations, when the second housing member 16 is in the first position of FIG. 1, the display surface 22 of the first display panel 20 may be occluded as previously described above. As a result, when the second housing member 16 is in the first position of FIG. 1, the controller 80 may deactivate the first display panel 20. In some examples, deactivating the first display panel 20 may comprise preventing some or all electrical power from being conducted to first display panel 20 so that images are not displayed thereon. However, when the second display panel 40 is transitioned to the second position of FIG. 2, the first display panel 20 is exposed as previously described. As a result, the controller 80 may activate the first display panel 20 such that first display panel 20 may display images thereon.

Controller 80 may determine that the second display panel 40 is in the first or second positions (FIGS. 1 and 2), based on an output from a suitable sensor (or sensors) (e.g., optical sensors, magnetic sensors). In some examples, the transition of the second display panel 40 between the first position (FIG. 1) and the second position (FIG. 2) may actuate a switch or a plurality of switches (e.g., mechanical switch(es), wireless node(s)) which may provide an indication to the controller 80 that the second display panel 40 is in the first position or the second position.

Referring still to FIG. 12, in some examples, a driver 90 may be coupled to the second display panel 40 and controller 80. The driver 90 may include an output shaft 92 that is coupled to second display panel 40. As used herein the term “driver” (e.g., driver 90) may broadly refer to any device that may perform work by moving (e.g., translating and/or rotating) another object. In some examples, driver 90 may comprise an electric motor, a pneumatic motor, a hydraulic motor, etc.

During operations, controller 80 may selectively actuate driver 90 to extend or withdrawal output shaft 92 so as to selectively transition the second display panel 40 between the first position (FIG. 1) and the second position (FIG. 2). The controller 80 may actuate driver 90 in response to an input (e.g., command) provided by the user (e.g., via input device 18). In some examples, controller 80 may actuate driver 90 in response to a command generated via an application being executed on electronic device 10. For instance, if a user launches an application that utilizes both display panels, the controller 80 may automatically actuate the second display panel 40 to the second position (FIG. 2) and activate the first display panel 20.

The examples disclosed herein include electronic devices that include a pair of display panels that may be slidable relative to one another to selectively increase an available surface area for displaying images on an electronic device during operations. In addition, when the additional display surface area is not needed or desired, a user may slide the display panels relative to one another to occlude one of the pair of display panels. Through use of the slidable display panels of the examples disclosed herein, a user may selectively increase or decrease the available surface area on the electronic device for displaying images to enhance both the user experience during operations and the transportability of the electronic device.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a hinge;
a housing comprising a first housing member pivotably coupled to a second housing member via the hinge;
wherein the first housing member comprises:
a first display panel comprising a first display surface and a first rear surface opposite the first display surface; and
a second display panel comprising a second display surface and a second rear surface opposite the second display surface,
wherein the second display panel is to slide along the first display panel between:
a first position in which the second display panel occludes the first display panel and the first rear surface is flush with the second rear surface to form a smooth back side of the first housing member; and
a second position in which the second display panel is translated away from the hinge from the first position to expose the first display panel.

2. The electronic device of claim 1, comprising a driver coupled to the second display panel, wherein the driver is to transition the second display panel between the first position and the second position.

3. The electronic device of claim 1, comprising a plurality of magnets coupled to the first housing member, wherein a magnetic attraction between the plurality of magnets is to resist transition of the second display panel from the first position to the second position.

4. The electronic device of claim 1, wherein the first display panel comprises a first stop surface, and the second display panel comprises a second stop surface, wherein when the second display panel is in the second position, the second stop surface is engaged with the first stop surface.

5. The electronic device of claim 1, comprising a controller positioned within the housing and coupled to the first display panel and the second display panel, wherein the controller is to:
activate the first display panel when the second display panel is in the second position; and
deactivate the first display panel when the second display panel is in the first position.

6. The electronic device of claim 1, wherein the second housing member comprises an input device.

7. The electronic device of claim 6, wherein the input device comprises a keyboard.

8. An electronic device, comprising:
a housing comprising a first housing member pivotably coupled to a second housing member about an axis of rotation; and
an input device coupled to the second housing member;
wherein the first housing member comprises a first display panel and a second display panel supported by the first housing member, wherein the second display panel is to slide relative to the first display panel along a radius of the axis of rotation, and wherein the second display panel is larger than the first display panel.

9. The electronic device of claim 8, wherein the first housing member is to rotate about the axis of rotation relative to the second housing member to simultaneously adjust a viewing angle of the first display panel and the second display panel.

10. The electronic device of claim 8, comprising a plurality of magnets coupled to the first housing member, wherein a magnetic attraction between the plurality of magnets is to resist movement of the second display panel away from the axis of rotation.

11. The electronic device of claim 8, comprising a driver coupled to the second display panel, wherein the driver is to slide the second display panel relative to the first display panel.

12. The electronic device of claim 11, comprising a controller positioned within the housing and coupled to the first display panel and the second display panel, wherein the controller is to:
activate the first display panel when the second display panel is in a second position; and
deactivate the first display panel when the second display panel is in a first position.

13. The electronic device of claim 8, wherein the input device comprises a keyboard and a trackpad.

14. The electronic device of claim 8, wherein a display surface of the first display panel has a first height measured along the radius, and a display surface of the second display panel has a second height measured along the radius, and wherein the first height is less than the second height.

15. An electronic device, comprising:
an input device;
a first display panel pivotably coupled to the input device via a hinge; and
a second display panel slidingly coupled to the first display panel such that the second display panel is to slide along the first display panel toward or away from the hinge.

16. The electronic device of claim 15, wherein the input device comprises a keyboard.

17. The electronic device of claim 15, wherein a display surface of the first display panel has a first height that is measured along a radius of an axis of rotation of the hinge and a display surface of the second display panel has a second height that is measured along the radius, and wherein the first height is less than the second height.

18. The electronic device of claim 15, comprising a controller coupled to the first display panel and the second display panel, wherein the controller is to:
activate the first display panel when the second display panel is slid along the first display panel away from the hinge; and
deactivate the first display panel when the second display panel is slid along the first display panel toward the hinge.

19. The electronic device of claim 15, comprising a driver coupled to the second display panel, wherein actuation of the driver is to slide the second display panel along the first display panel toward or away from the hinge.

20. The electronic device of claim 15, comprising a spring coupled to the second display panel, wherein sliding the second display panel along the first display panel away from the hinge is to compress and then expand the spring.
